(19) United States
(12) Patent Application Publication
(10) Pub. No.: US 2025/0391614 A1
(43) Pub. Date: Dec. 25, 2025

(54) CAPACITOR ELEMENT

(71) Applicant: Murata Manufacturing Co., Ltd., Nagaokakyo-shi (JP)

(72) Inventors: Takahisa HIAI, Nagaokakyo-shi (JP); Yasushi Sakaguchi, Nagaokakyo-shi (JP); Akitomo Takahashi, Nagokakyo-shi (JP)

(21) Appl. No.: 19/308,429

(22) Filed: Aug. 25, 2025

Related U.S. Application Data
(63) Continuation of application No. PCT/JP2024/008023, filed on Mar. 4, 2024.

(30) Foreign Application Priority Data
Apr. 14, 2023 (JP) 2023-066554

(51) Int. Cl. H01G 9/26; H01G 9/012; H01G 9/10; H01G 9/15

(52) U.S. Cl. CPC H01G 9/26; H01G 9/10; H01G 9/15; H01G 9/012

(57) ABSTRACT

A capacitor element including: a planar capacitor layer; and a sealing layer that includes a first insulation portion covering a first main surface of the capacitor layer and a second insulation portion covering a second main surface of the capacitor layer, the capacitor layer includes a plurality of through portions passing therethrough, the plurality of through portions include one or more first through portions and one or more second through portions, a width of an end portion of the first through portions on a first insulation portion side is larger than a width of an end portion of the first through portions on a second insulation portion side, and a width of an end portion of the second through portions on the first insulation portion side is smaller than a width of an end portion of the second through portions on the second insulation portion side.

### CROSS REFERENCE TO RELATED APPLICATIONS

The present application is a continuation of International application No. PCT/JP2024/008023, filed Mar. 4, 2024, which claims priority to Japanese Patent Application No. 2023-066554, filed Apr. 14, 2023, the entire contents of each of which are incorporated herein by reference.

### TECHNICAL FIELD

The present disclosure relates to a capacitor element.

### BACKGROUND ART

Patent Document 1 discloses a capacitor array including: a plurality of solid electrolytic capacitor elements into which one solid electrolytic capacitor sheet is divided; a sheet-shaped first sealing layer; and a sheet-shaped second sealing layer. The solid electrolytic capacitor sheet includes an anode plate composed of a valve metal, a porous layer located on at least one of the main surfaces of the anode plate, a dielectric layer located on the surface of the porous layer, and a cathode layer including a solid electrolyte layer located on the surface of the dielectric layer. The solid electrolytic capacitor sheet has a first main surface and a second main surface opposed to each other in the thickness direction. Each of the solid electrolytic capacitor elements is located with its first main surface side on the first sealing layer, and the second sealing layer covers the second main surface sides of the plurality of solid electrolytic capacitor elements located on the first sealing layer. The solid electrolytic capacitor elements are separated by sheet-removed portions in the form of slits.

Patent Document 1: Japanese Unexamined Patent Application Publication No. 2020-167361

### SUMMARY OF THE DISCLOSURE

A conventional capacitor array such as the capacitor array described in Patent Document 1 includes a plurality of through holes (through portions) for providing through electrodes used for the connection between the anode layer (the anode plate) and an outer electrode layer, the connection between the cathode layers and an outer electrode layer, and the like. However, in a conventional capacitor array, in the case in which a plurality of through holes are formed by laser processing or the like, the diameter of each through hole is sometimes larger or smaller on one main surface side of the capacitor array than on the other main surface side. Hence, in a conventional capacitor array, the sizes of various components, in particular, the size of a sealing layer, (for example, the area when viewed in the thickness direction) are sometimes significantly different between the one main surface side and the other main surface side of the capacitor array. Hence, characteristics (for example, thermal characteristics and stiffness) of a conventional capacitor array are sometimes significantly different between one main surface side and the other main surface side. Thus, in a conventional capacitor array, the difference in characteristics between one main surface side and the other main surface side can result in the occurrence of a warp or the like, causing the deterioration in the flatness.

The present disclosure has been made to solve the above problem, and an object thereof is to provide a capacitor element that exhibits less deterioration in the flatness although it includes a plurality of through portions.

A capacitor element of the present disclosure includes: a planar capacitor layer parallel to a plane direction perpendicular to a thickness direction and including one or more capacitor portions, wherein the capacitor portions include an anode layer, a dielectric layer, and a cathode layer facing the anode layer with the dielectric layer interposed therebetween in the thickness direction; and a sealing layer composed of an insulating material and sealing the capacitor layer from two main surface sides of the capacitor layer opposed to each other in the thickness direction, wherein the sealing layer includes a first insulation portion covering a first main surface of the capacitor layer and a second insulation portion covering a second main surface of the capacitor layer, at least the capacitor layer includes a plurality of through portions passing through at least the capacitor layer in the thickness direction, the plurality of through portions include one or more first through portions and one or more second through portions, a width of an end portion of each of the first through portions on a first insulation portion side is larger than a width of an end portion of each of the first through portions on a second insulation portion side, and a width of an end portion of each of the second through portions on the first insulation portion side is smaller than a width of an end portion of each of the second through portions on the second insulation portion side.

With the present disclosure, it is possible to provide a capacitor element that exhibits less deterioration in the flatness although it includes a plurality of through portions.

### BRIEF DESCRIPTION OF THE DRAWINGS

FIG. 1 is a schematic plan view of an example of a

capacitor element of the present disclosure.

FIG. 2 is a schematic cross-sectional view of an example of a cross section of the capacitor element illustrated in FIG. 1, taken along line segment a1-a2.

FIG. 3 is a schematic cross-sectional view of an example of a cross section of the capacitor element illustrated in FIG. 1, taken along line segment b1-b2.

FIG. 4 is a schematic plan view of another example of a capacitor element of the present disclosure.

FIG. 5 is a schematic cross-sectional view of an example of a cross section of the capacitor element illustrated in FIG. 4, taken along line segment c1-c2.

FIG. 6 is a schematic cross-sectional view of an example of a cross section of the capacitor element illustrated in FIG. 4, taken along line segment d1-d2.

### DESCRIPTION OF THE PREFERRED EMBODIMENTS

Hereinafter, a capacitor element of the present disclosure will be described. The present disclosure is not limited to the following configurations, which may be changed as appropriate within a range not departing from the spirit of the present disclosure. Combinations of two or more individual preferred configurations described in the following are also included in the present disclosure.

The drawings described in the following are schematic, and hence, the dimensions, the scale of the ratio of longitudinal dimensions and lateral dimensions, and the like sometimes differ from those of the actual product.

In the present specification, the terms indicating the relationships between components (for example, “parallel”, “perpendicular”, and the like) and the terms indicating the shapes of components not only denote literal configurations in a strict sense but also include substantially equivalent ranges, for example, ranges including differences of several percent.

A capacitor element of the present disclosure includes: a planar capacitor layer parallel to plane directions perpendicular to a thickness direction and including one or more capacitor portions; and a sealing layer composed of an insulating material and sealing the capacitor layer from two main surface sides of the capacitor layer opposed to each other in the thickness direction, the capacitor portions include an anode layer, a dielectric layer, and a cathode layer facing the anode layer with the dielectric layer interposed therebetween in the thickness direction, the sealing layer includes a first insulation portion covering one main surface of the capacitor layer and a second insulation portion covering the other main surface of the capacitor layer, at least the capacitor layer includes a plurality of through portions passing through at least the capacitor layer in the thickness direction, the plurality of through portions include one or more first through portions and one or more second through portions, the width of an end portion of each first through portion on the first insulation portion side is larger than the width of an end portion of the first through portion on the second insulation portion side, and the width of an end portion of each second through portion on the first insulation portion side is smaller than the width of an end portion of the second through portion on the second insulation portion side.

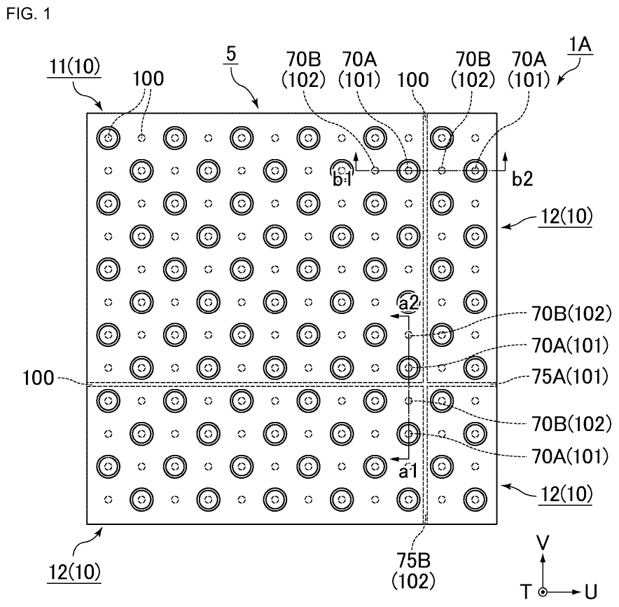

FIG. 1 is a schematic plan view of an example of a capacitor element of the present disclosure.

The capacitor element 1A illustrated in FIG. 1 includes a capacitor layer 5.

The capacitor layer 5 has a planar shape parallel to the plane directions perpendicular to the thickness direction T. In the example illustrated in FIG. 1, the capacitor layer 5 has a planar shape parallel to the plane directions including a first direction U perpendicular to the thickness direction T and a second direction V perpendicular to the thickness direction T and the first direction U.

The capacitor layer 5 includes one or more capacitor portions 10. In the example illustrated in FIG. 1, the capacitor layer 5 includes a plurality of (in FIG. 1, four) capacitor portions 10.

The number of capacitor portions 10 in the capacitor layer 5 may be one, or two or more.

The plurality of capacitor portions 10 may be arranged in a plane in the plane directions. In the example illustrated in FIG. 1, the plurality of capacitor portions 10 are arranged in a plane parallel to the first direction U and the second direction V.

The plurality of capacitor portions 10 may be arranged in a plane in a plurality of directions or in one direction, out of the plane directions. The plurality of capacitor portions 10 may be arranged in a plane regularly or irregularly.

Examples of the planar shape of each capacitor portion 10 viewed in the thickness direction T include rectangles (squares or non-square rectangles); polygons such as quadrilaterals excluding rectangles, triangles, pentagons, and hexagons; circles; and ellipses.

The planar shapes of the plurality of capacitor portions 10 viewed in the thickness direction T may be the same, may be different, or may be partially different.

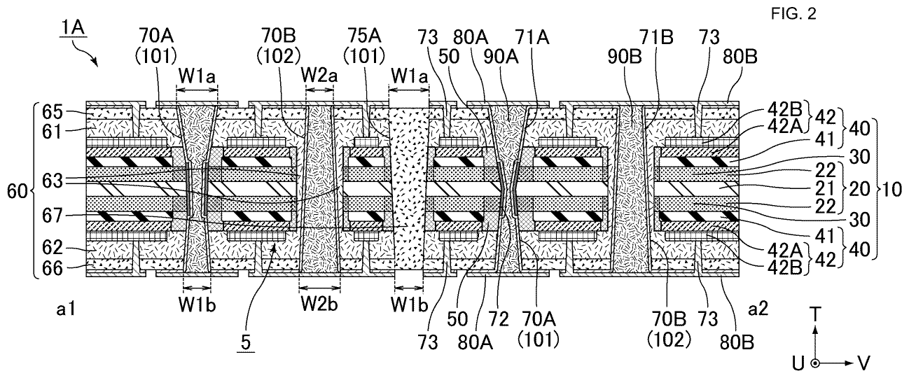

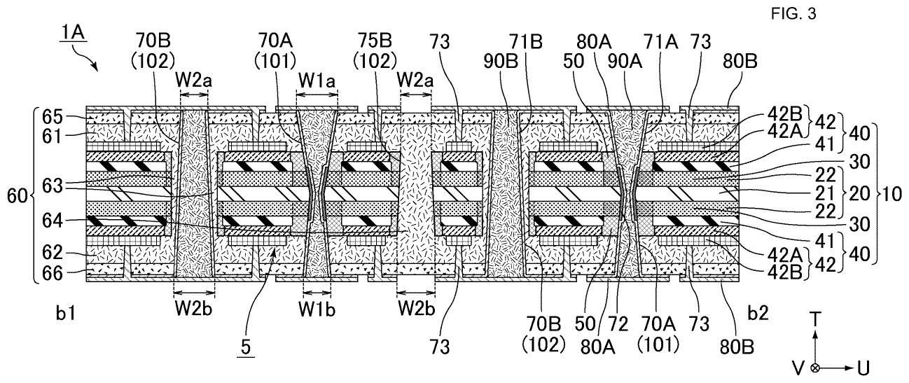

FIG. 2 is a schematic cross-sectional view of an example of a cross section of the capacitor element illustrated in FIG. 1, taken along line segment a1-a2. FIG. 3 is a schematic cross-sectional view of an example of a cross section of the capacitor element illustrated in FIG. 1, taken along line segment b1-b2.

In the capacitor element 1A illustrated in FIGS. 2 and 3, the capacitor portions 10 include an anode layer 20, dielectric layers 30, and cathode layers 40.

The following describes an example of a configuration in which the capacitor portions 10 serve as electrolytic capacitors.

The anode layer 20 includes and a core portion 21 and porous portions 22.

It is preferable that the core portion 21 be composed of a metal, in particular, a valve metal. In the case in which the core portion 21 is composed of a valve metal, the anode layer 20 is also referred to as a valve metal substrate.

Examples of the valve metal include pure metals such as aluminum, tantalum, niobium, titanium, and zirconium and alloys containing at least one of these pure metals. Among these, aluminum or aluminum alloys are preferable.

A porous portion 22 is located on at least one main surface of the two main surfaces of the core portion 21 opposed to each other in the thickness direction T. In other words, the porous portion 22 may be located on only one main surface of the core portion 21 or may be located on both main surfaces of the core portion 21. As described above, the anode layer 20 includes a porous portion 22 on at least one main surface of the two main surfaces opposed to each other in the thickness direction T. This enables the surface area of the anode layer 20 to be large, making it easy to improve the capacitance of the capacitor portion 10.

It is preferable that the porous portion 22 be an etching layer formed by etching a surface of the anode layer 20.

It is preferable that the anode layer 20 have a flat plate shape (an anode plate), and it is more preferable that the anode layer 20 have a foil shape (an anode foil).

In the present specification, plate shapes include foil shapes, sheet shapes, and film shapes, and these are not discriminated according to the dimensions in the thickness direction.

Each dielectric layer 30 is located on the surface of the corresponding porous portion 22. More specifically, each dielectric layer 30 is located along the surface (outline) of micropores in the corresponding porous portion 22.

It is preferable that the dielectric layer 30 be composed of an oxide film of a valve metal mentioned above. For example, in the case in which the anode layer 20 is composed of an aluminum foil, an oxide film serving as the dielectric layer 30 is formed by performing anodic oxidation (which is also referred to as a chemical conversion treatment) on the anode layer 20 in a water solution containing ammonium adipate or the like. Since the dielectric layer 30 is formed along the surface of the porous portion 22, the dielectric layer 30 has micropores (recesses).

Each cathode layer 40 faces the anode layer 20 with the corresponding dielectric layer 30 interposed therebetween in the thickness direction T.

The cathode layer 40 is located on the surface of the dielectric layer 30.

It is preferable that each cathode layer 40 include a solid electrolyte layer 41 located on the surface of the dielectric layer 30 and a conductor layer 42 located on the surface of the solid electrolyte layer 41. In the case in which the cathode layer 40 includes a solid electrolyte layer 41, the capacitor portions 10 serve as solid electrolytic capacitors.

It is preferable that the solid electrolyte layer 41 include an inner layer located inside the micropores of the dielectric layer 30 and an outer layer covering the inner layer.

Examples of the constituent material of the solid electrolyte layer 41 include conductive polymers such as polypyrroles, polythiophenes, and polyanilines. Among these, polythiophenes are preferable, and in particular, poly(3,4-ethylenedioxythiophene) (PEDOT) is preferable. The conductive polymer may contain a dopant such as polystyrene sulfonic acid (PSS).

The solid electrolyte layer 41 is formed in a specified region on the surface of the dielectric layer 30, for example, by a method including applying a dispersion of a conductive polymer such as poly(3,4-ethylenedioxythiophene) onto the surface of the dielectric layer 30 and drying it, a method including forming a film of a polymer such as poly(3,4-ethylenedioxythiophene) on the surface of the dielectric layer 30 by using a treatment liquid containing a polymerizable monomer such as 3,4-ethylenedioxythiophene, or other methods.

The conductor layer 42 preferably includes a conductive resin layer 42A located on the surface of the solid electrolyte layer 41 and a metal layer 42B located on the surface of the conductive resin layer 42A.

Examples of the conductive resin layer 42A include a conductive adhesive layer containing at least one kind of conductive fillers selected from the group of copper fillers, silver fillers, nickel fillers, and carbon fillers.

It is preferable that the metal layer 42B contain metal fillers.

It is preferable that the metal fillers be at least one kind of fillers selected from the group of copper fillers, silver fillers, and nickel fillers.

The metal layer 42B may be, for example, a metal plating film, a metal foil, or the like. In this case, it is preferable that the metal layer 42B be composed of at least one kind of metal selected from the group of copper, silver, nickel, and alloys containing at least one of these metals as the main component.

In the present specification, the main component denotes the element component having the largest weight ratio.

The conductor layer 42 may include, for example, a carbon layer serving as the conductive resin layer 42A and a copper layer serving as the metal layer 42B.

The carbon layer is formed in a specified region, for example, by applying a carbon paste containing carbon fillers onto the surface of the solid electrolyte layer 41 by a sponge transfer method, a screen printing method, a dispenser application method, an inkjet printing method, or the like.

The copper layer is formed in a specified region, for example, by applying a copper paste containing copper fillers onto the surface of the carbon layer by a sponge transfer method, a screen printing method, a spray application method, a dispenser application method, an inkjet printing method, or the like.

The conductor layer 42 may include at least one of the conductive resin layer 42A and the metal layer 42B. Specifically, the conductor layer 42 may include only the conductive resin layer 42A, may include only the metal layer 42B, or may include both the conductive resin layer 42A and the metal layer 42B.

The capacitor portion 10 preferably further includes mask layers 50 located at peripheral edges of the porous portions 22 when viewed in the thickness direction T.

The mask layers 50 are preferably provided over the entire peripheral edges of the porous portions 22 viewed in the thickness direction T. However, the mask layers 50 may be provided at part of the peripheral edges of the porous portions 22 viewed in the thickness direction T.

It is preferable that the mask layer 50 extend inward in the thickness direction T from at least one main surface of the two main surfaces of the anode layer 20, and it is more preferable that the mask layers 50 extend inward from both main surfaces of the anode layer 20.

The mask layers 50 may be, but need not be, in contact with the core portion 21 in the thickness direction T.

The mask layers 50 may be located not only inside the porous portions 22 but also outside the porous portions 22. In this case, the mask layers 50 may be infiltrated into the porous portions 22 and also located on the surface of the porous portions 22 where the mask layers 50 are infiltrated.

In other words, the dimension of the mask layer 50 in the thickness direction T may be larger than the dimension of the porous portion 22 in the thickness direction T.

In the case in which the mask layers 50 are also located outside the porous portions 22, it is preferable that the mask layers 50 be located in regions surrounding the cathode layers 40 when viewed in the thickness direction T.

When viewed in the thickness direction T, the mask layers 50 may partially overlap the cathode layers 40, but a configuration in which the mask layers 50 do not overlap the cathode layers 40 at all is also possible.

It is preferable that the mask layers 50 be composed of an insulating material. This configuration provides sufficient insulation between the anode layer 20 and the cathode layers 40, sufficiently preventing a short circuit between them.

Examples of the insulating material composing the mask layers 50 include polyphenylsulfone (PPS), polyethersulfone (PES), cyanate ester resins, fluororesins (tetrafluoroethylene, tetrafluoroethylene-perfluoroalkylvinyl ether copolymer, and the like), compositions including a soluble polyimide siloxane and an epoxy resin, polyimide resins, polyamideimide resins, derivatives or precursors of one of these.

The mask layers 50 are formed along the peripheral edges of the porous portions 22, for example, by applying a foregoing insulating material onto the portions of both main surfaces of the anode layer 20, overlapping the peripheral edges of the porous portions 22, and infiltrating the applied material inward from the two main surfaces of the anode layer 20.

The mask layer 50 may be formed in the porous portions 22 before the dielectric layers 30 are formed or after the dielectric layers 30 are formed.

The capacitor element 1A illustrated in FIGS. 2 and 3 further includes sealing layers 60 in addition to the capacitor layer 5.

The sealing layers 60 seal the capacitor layer 5 from both main surfaces sides of the capacitor layer 5 opposed to each other in the thickness direction T. This enables the capacitor layer 5 to be protected by the sealing layers 60.

The sealing layers 60 are composed of an insulating material. In other words, the sealing layers 60 function as insulation layers.

The insulating material composing the sealing layers 60 may contain an insulating resin.

Examples of the insulating resin contained in the insulating material composing the sealing layers 60 include epoxy resins, phenol resins, and polyimide resins.

The insulating material composing the sealing layers 60 may further contain inorganic fillers.

Examples of the inorganic fillers contained in the insulating material composing the sealing layers 60 include silica fillers and alumina fillers.

The sealing layers 60 are formed to seal the capacitor layer 5 from both main surfaces sides of the capacitor layer 5, for example, by a method including thermal pressure bonding of insulating resin sheets, a method including applying an insulating resin paste and then heat-curing it, or other methods.

The sealing layers 60 include a first insulation portion 61 and a second insulation portion 62.

The first insulation portion 61 covers one main surface of the capacitor layer 5. In the example illustrated in FIGS. 2 and 3, the first insulation portion 61 covers the cathode layer 40 and the mask layer 50 composing one main surface of the capacitor layer 5 (the capacitor portions 10).

The first insulation portion 61 overlaps the capacitor portions 10 when viewed in the thickness direction T.

The second insulation portion 62 covers the other main surface of the capacitor layer 5. In the example illustrated in FIGS. 2 and 3, the second insulation portion 62 covers the cathode layer 40 and the mask layer 50 composing the other main surface of the capacitor layer 5 (the capacitor portions 10).

The second insulation portion 62 overlaps the capacitor portions 10 when viewed in the thickness direction T.

As described above, the first insulation portion 61 and the second insulation portion 62 are formed to conform to the surface shapes of the capacitor layer 5 (the capacitor portions 10).

It is preferable that the insulating materials composing the first insulation portion 61 and the second insulation portion 62 contain the same insulating resin.

In the present specification, the expression “the insulating materials composing a plurality of insulation portions contain the same insulating resin” denotes that at least the kind of insulating resin is the same in the insulating material composing each of the insulation portions, and denotes that the ratio of the insulating resin content to the total amount of insulating material is preferably the same in each insulation portion, in addition to the kind of insulating resin.

The insulating materials composing the first insulation portion 61 and the second insulation portion 62 may contain different insulating resins.

In the present specification, the expression “the insulating materials composing a plurality of insulation portions contain different insulating resins or partially contain different insulating resins” denotes that at least the kind of insulating resin is different or partially different in the insulating materials composing the plurality of insulation portions, and denotes that the ratio of the insulating resin content to the total amount of insulating material is preferably different or partially different, in addition to the kind of insulating resin.

It is preferable that the insulating materials composing the first insulation portion 61 and the second insulation portion 62 contain the same inorganic fillers.

In the present specification, the expression “the insulating materials composing a plurality of insulation portions contain the same inorganic fillers” denotes that at least the kind of inorganic fillers is the same in the insulating material composing each of the insulation portions, and denotes that the ratio of the inorganic filler content to the total amount of insulating material is preferably the same in each insulation portion, in addition to the kind of inorganic fillers.

The insulating materials composing the first insulation portion 61 and the second insulation portion 62 may contain different inorganic fillers.

In the present specification, the expression “the insulating materials composing a plurality of insulation portions contain different inorganic fillers or partially contain different inorganic fillers” denotes that at least the kind of inorganic fillers is different or partially different in the insulating materials composing the plurality of insulation portions, and denotes that the ratio of the inorganic filler content to the total amount of insulating material is preferably different or partially different, in addition to the kind of inorganic filler.

The first insulation portion 61 and the second insulation portion 62 are formed to cover both main surfaces of the capacitor layer 5, for example, by a method including thermal pressure bonding of insulating resin sheets, a method including applying an insulating resin paste and then heat-curing it, or other methods.

The sealing layers 60 preferably further include third insulation portions 63 passing through the capacitor portions 10 in the thickness direction T. In the example illustrated in FIGS. 2 and 3, the third insulation portions 63 pass through the anode layer 20 and the mask layer 50 of each of the capacitor portions 10 in the thickness direction T.

The first insulation portion 61, the second insulation portion 62, and the third insulation portions 63 may be integrated, and the interfaces between the insulation portions need not be present.

However, the first insulation portion 61, the second insulation portion 62, and the third insulation portions 63 are not limited to being integrated, and the interfaces between the insulation portions may be present.

It is preferable that the insulating materials composing the first insulation portion 61, the second insulation portion 62, and the third insulation portions 63 contain the same insulating resin; however, these insulating materials may contain different insulating resins, or may partially contain different insulating resins.

It is preferable that the insulating materials composing the first insulation portion 61, the second insulation portion 62, and the third insulation portions 63 contain the same inorganic fillers; however, these insulating materials may contain different inorganic fillers, or may partially contain different inorganic fillers.

The third insulation portions 63 are formed to pass through the capacitor portions 10 in the thickness direction T, for example, in the course of the first insulation portion 61 and the second insulation portion 62 being formed in an above-mentioned method.

The sealing layers 60 preferably further include a fourth insulation portion 64 dividing the plurality of capacitor portions 10 individually. In the example illustrated in FIG. 3, the fourth insulation portion 64 fills a space between two adjacent capacitor portions 10 so as to divide the adjacent capacitor portions 10 individually.

The first insulation portion 61, the second insulation portion 62, and the fourth insulation portion 64 may be integrated, and the interfaces between the insulation portions need not be present.

However, the first insulation portion 61, the second insulation portion 62, and the fourth insulation portion 64 are not limited to being integrated, and the interfaces between the insulation portions may be present.

It is preferable that the insulating materials composing the first insulation portion 61, the second insulation portion 62, and the fourth insulation portion 64 contain the same insulating resin; however, these insulating materials may contain different insulating resins, or may partially contain different insulating resins.

It is preferable that the insulating materials composing the first insulation portion 61, the second insulation portion 62, and the fourth insulation portion 64 contain the same inorganic fillers; however, these insulating materials may contain different inorganic fillers, or may partially contain different inorganic fillers.

The fourth insulation portion 64 is formed to fill spaces between the plurality of capacitor portions 10, for example, in the course of the first insulation portion 61 and the second insulation portion 62 being formed in an above-mentioned method.

It is preferable that the insulating materials composing the first insulation portion 61, the second insulation portion 62, the third insulation portions 63, and the fourth insulation portion 64 contain the same insulating resin; however, these insulating materials may contain different insulating resins, or may partially contain different insulating resins.

It is preferable that the insulating materials composing the first insulation portion 61, the second insulation portion 62, the third insulation portions 63, and the fourth insulation portion 64 contain the same inorganic fillers; however, these insulating materials may contain different inorganic fillers, or may partially contain different inorganic fillers.

The sealing layers 60 preferably further include a fifth insulation portion 65 adjoining the side of the first insulation portion 61 opposite to the capacitor layer 5 such that an interface with the first insulation portion 61 is present.

It is preferable that the insulating materials composing the first insulation portion 61 and the fifth insulation portion 65 contain different insulating resins; however these insulating materials may contain the same insulating resin.

In the case in which the insulating materials composing the first insulation portion 61 and the fifth insulation portion 65 contain different insulating resins, the fifth insulation portion 65 is more likely to have characteristics different from those of the first insulation portion 61.

Since the first insulation portion 61 covers one main surface of the capacitor layer 5 (the capacitor portions 10), it is desired to have characteristics that enhance conformance to the surface shape of the capacitor layer 5 (the capacitor portions 10). In contrast, the fifth insulation portion 65 is desired to preferably have characteristics that increases the flatness so as to ensure the flatness of the capacitor element 1A because the fifth insulation portion 65 is located at the outermost surface of the sealing layers 60 in the example illustrated in FIGS. 2 and 3. As described above, it is preferable that the fifth insulation portion 65 have characteristics different from those of the first insulation portion 61.

The insulating materials composing the first insulation portion 61 and the fifth insulation portion 65 may contain the same or different inorganic fillers.

The insulating material composing the fifth insulation portion 65 may contain a glass cloth. In this case, the stiffness of the fifth insulation portion 65 is more likely to be high, and the flatness of the fifth insulation portion 65 is more likely to be kept. This makes it easy to keep the flatness of the capacitor element 1A.

Examples of insulating materials containing a glass cloth include prepreg.

After the first insulation portion 61 is formed by an above-mentioned method, the fifth insulation portion 65 is formed to adjoin the side of the first insulation portion 61 opposite to the capacitor layer 5 by, for example, a method including thermal pressure bonding of an insulating resin sheet, a method including applying an insulating resin paste and then heat-curing it, or other methods. As described above, since the fifth insulation portion 65 is formed on the first insulation portion 61 by a build-up method, the already formed first insulation portion 61 does not need to be soften by a heat treatment when the fifth insulation portion 65 is formed. Thus, when the fifth insulation portion 65 is formed, the first insulation portion 61 and the fifth insulation portion 65 are not integrated, and an interface is formed between the first insulation portion 61 and the fifth insulation portion 65.

The sealing layers 60 preferably further include a sixth insulation portion 66 adjoining the side of the second insulation portion 62 opposite to the capacitor layer 5 such that an interface with the second insulation portion 62 is present.

It is preferable that the insulating materials composing the second insulation portion 62 and the sixth insulation portion 66 contain different insulating resins; however these insulating materials may contain the same insulating resin.

In the case in which the insulating materials composing the second insulation portion 62 and the sixth insulation portion 66 contain different insulating resins, the sixth insulation portion 66 is more likely to have characteristics different from those of the second insulation portion 62.

Since the second insulation portion 62 covers one main surface of the capacitor layer 5 (the capacitor portions 10), it is desired to have characteristics that enhance conformance to the surface shape of the capacitor layer 5 (the capacitor portions 10). In contrast, the sixth insulation portion 66 is desired to preferably have characteristics that increases the flatness so as to ensure the flatness of the capacitor element 1A because the sixth insulation portion 66 is located at the outermost surface of the sealing layers 60 in the example illustrated in FIGS. 2 and 3. As described above, it is preferable that the sixth insulation portion 66 have characteristics different from those of the second insulation portion 62.

The insulating materials composing the second insulation portion 62 and the sixth insulation portion 66 may contain the same or different inorganic fillers.

The insulating material composing the sixth insulation portion 66 may contain a glass cloth. In this case, the stiffness of the sixth insulation portion 66 is more likely to be high, and the flatness of the sixth insulation portion 66 is more likely to be kept. This makes it easy to keep the flatness of the capacitor element 1A.

After the second insulation portion 62 is formed by an above-mentioned method, the sixth insulation portion 66 is formed to adjoin the side of the second insulation portion 62 opposite to the capacitor layer 5 by, for example, a method including thermal pressure bonding of an insulating resin sheet, a method including applying an insulating resin paste and then heat-curing it, or other methods. As described above, since the sixth insulation portion 66 is formed on the second insulation portion 62 by a build-up method, the already formed second insulation portion 62 does not need to be soften by a heat treatment when the sixth insulation portion 66 is formed. Thus, when the sixth insulation portion 66 is formed, the second insulation portion 62 and the sixth insulation portion 66 are not integrated, and an interface is formed between the second insulation portion 62 and the sixth insulation portion 66.

The sealing layers 60 preferably further include a seventh insulation portion 67 dividing the plurality of capacitor portions 10 individually. In the example illustrated in FIG. 2, the seventh insulation portion 67 fills a space between two adjacent capacitor portions 10 so as to divide the adjacent capacitor portions 10 individually.

The fifth insulation portion 65, the sixth insulation portion 66, and the seventh insulation portion 67 may be integrated, and the interfaces between the insulation portions need not be present.

However, the fifth insulation portion 65, the sixth insulation portion 66, and the seventh insulation portion 67 are not limited to being integrated, and the interfaces between the insulation portions may be present.

It is preferable that the insulating materials composing the fifth insulation portion 65, the sixth insulation portion 66, and the seventh insulation portion 67 contain the same insulating resin; however, these insulating materials may contain different insulating resins, or may partially contain different insulating resins.

It is preferable that the insulating materials composing the fifth insulation portion 65, the sixth insulation portion 66, and the seventh insulation portion 67 contain the same inorganic fillers; however, these insulating materials may contain different inorganic fillers, or may partially contain different inorganic fillers.

The seventh insulation portion 67 is formed to fill spaces between the plurality of capacitor portions 10, for example, in the course of the fifth insulation portion 65 and the sixth insulation portion 66 being formed in an above-mentioned method.

In the capacitor element 1A illustrated in FIG. 1, at least the capacitor layer 5 has a plurality of through portions 100 passing through at least the capacitor layer 5 in the thickness direction T.

The plurality of through portions 100 include one or more first through portions 101 and one or more second through portions 102.

In the capacitor element 1A illustrated in FIGS. 2 and 3, the width W1a (the dimension in the second direction V in FIG. 2, and the dimension in the first direction U in FIG. 3) of the end portion of each first through portion 101 on the first insulation portion 61 side is larger than the width W1b (the dimension in the second direction V in FIG. 2, and the dimension in the first direction U in FIG. 3) of the end portion of the first through portion 101 on the second insulation portion 62 side.

In the capacitor element 1A illustrated in FIGS. 2 and 3, the first through portions 101 pass through, in addition to the capacitor layer 5 (the capacitor portions 10), the sealing layers 60, more specifically, the first insulation portion 61, the second insulation portion 62, the fifth insulation portion 65, and the sixth insulation portion 66 in the thickness direction T. Hence, the end portion of each first through portion 101 on the first insulation portion 61 side is not defined at the same position in the first through portion 101 as the one main surface of the capacitor layer 5 (the capacitor portions 10) but is defined at the same position as the main surface of the sealing layers 60 on the first insulation portion 61 side, more specifically, the same position as the surface of the fifth insulation portion 65 opposite to the first insulation portion 61. In addition, the end portion of the first through portion 101 on the second insulation portion 62 side is not defined at the same position in the first through portion 101 as the other main surface of the capacitor layer 5 (the capacitor portions 10) but is defined at the same position as the main surface of the sealing layers 60 on the second insulation portion 62 side, more specifically, the same position as the surface of the sixth insulation portion 66 opposite to the second insulation portion 62.

In the capacitor element 1A illustrated in FIGS. 2 and 3, the width W2a (the dimension in the second direction V in FIG. 2, and the dimension in the first direction U in FIG. 3) of the end portion of each second through portion 102 on the first insulation portion 61 side is smaller than the width W2b (the dimension in the second direction V in FIG. 2, and the dimension in the first direction U in FIG. 3) of the end portion of the second through portion 102 on the second insulation portion 62 side.

In the capacitor element 1A illustrated in FIGS. 2 and 3, the second through portions 102 pass through, in addition to the capacitor layer 5 (the capacitor portions 10), the sealing layers 60, more specifically, the first insulation portion 61, the second insulation portion 62, the fifth insulation portion 65, and the sixth insulation portion 66 in the thickness direction T. Hence, the end portion of each second through portion 102 on the first insulation portion 61 side is not defined at the same position in the second through portion 102 as the one main surface of the capacitor layer 5 (the capacitor portions 10) but is defined at the same position as the main surface of the sealing layers 60 on the first insulation portion 61 side, more specifically, the same position as the surface of the fifth insulation portion 65 opposite to the first insulation portion 61. In addition, the end portion of the second through portion 102 on the second insulation portion 62 side is not defined at the same position in the second through portion 102 as the other main surface of the capacitor layer 5 (the capacitor portions 10) but is defined at the same position as the main surface of the sealing layers 60 on the second insulation portion 62 side, more specifically, the same position as the surface of the sixth insulation portion 66 opposite to the second insulation portion 62.

In the capacitor element 1A, since the widths of both end portions of each of the first through portions 101 and the second through portions 102 satisfy the above-mentioned relationship, the size of various components, in particular, the size of the sealing layers 60 (for example, the area viewed in the thickness direction T) is easily balanced between one main surface side of the capacitor element 1A (in FIGS. 2 and 3, the main surface on the first insulation portion 61 side) and the other main surface side (in FIGS. 2 and 3, the main surface on the second insulation portion 62 side). Hence, in the capacitor element 1A, characteristics (for example, thermal characteristics and stiffness) are easily balanced between one main surface side and the other main surface side, so that a warp or the like resulting from the difference in characteristics is less likely to occur, reducing the likelihood of the deterioration in the flatness.

With the configuration mentioned above, although the capacitor element 1A has a plurality of through portions 100, it is possible to achieve a capacitor element that exhibits less deterioration in the flatness.

It is preferable that the width W1a of the end portion of the first through portion 101 on the first insulation portion 61 side be larger than the width W2a of the end portion of the second through portion 102 on the first insulation portion 61 side.

However, the width W1a of the end portion of the first through portion 101 on the first insulation portion 61 side may also be the same as or smaller than the width W2a of the end portion of the second through portion 102 on the first insulation portion 61 side.

It is preferable that the width W1a of the end portion of the first through portion 101 on the first insulation portion 61 side be the same as the width W2b of the end portion of the second through portion 102 on the second insulation portion 62 side.

However, the width W1a of the end portion of the first through portion 101 on the first insulation portion 61 side may also be larger than or smaller than the width W2b of the end portion of the second through portion 102 on the second insulation portion 62 side.

It is preferable that the width W1b of the end portion of the first through portion 101 on the second insulation portion 62 side be smaller than the width W2b of the end portion of the second through portion 102 on the second insulation portion 62 side.

However, the width W1b of the end portion of the first through portion 101 on the second insulation portion 62 side may also be the same as or larger than the width W2b of the end portion of the second through portion 102 on the second insulation portion 62 side.

It is preferable that the width W1b of the end portion of the first through portion 101 on the second insulation portion 62 side be the same as the width W2a of the end portion of the second through portion 102 on the first insulation portion 61 side.

However, the width W1b of the end portion of the first through portion 101 on the second insulation portion 62 side may also be larger than or smaller than the width W2a of the end portion of the second through portion 102 on the first insulation portion 61 side.

Regarding the first through portion 101, as long as the width W1a of the end portion on the first insulation portion 61 side is larger than the width W1b of the end portion on the second insulation portion 62 side, the cross-sectional shape parallel to the thickness direction T is not particularly limited. For example, it may be a tapered shape the width of which decreases from the first insulation portion 61 side toward the second insulation portion 62 side or may be a waisted shape the width of which is smallest at a position halfway from the first insulation portion 61 side toward the second insulation portion 62 side. In the case in which the cross-sectional shape, parallel to the thickness direction T, of the first through portion 101 is a waisted shape the width of which is smallest at a position halfway from the first insulation portion 61 side toward the second insulation portion 62 side, the outline of the waisted shape of the first through portion 101 is not particularly limited. For example, it may be an outline such as that of the first through portion 101 on the left side in FIG. 2 or may be an outline such as that of the first through portion 101 on the right side in FIG. 2. As described above, in the waisted shape of the first through portion 101, the position at which the width is smallest is not particularly limited.

Regarding the second through portion 102, as long as the width W2a of the end portion on the first insulation portion 61 side is smaller than the width W2b of the end portion on the second insulation portion 62 side, the cross-sectional shape parallel to the thickness direction T is not particularly limited. For example, it may be a tapered shape the width of which increases from the first insulation portion 61 side toward the second insulation portion 62 side or may be a waisted shape the width of which is smallest at a position halfway from the first insulation portion 61 side toward the second insulation portion 62 side. In the case in which the cross-sectional shape, parallel to the thickness direction T, of the second through portion 102 is a waisted shape the width of which is smallest at a position halfway from the first insulation portion 61 side toward the second insulation portion 62 side, the outline of the waisted shape of the second through portion 102 is not particularly limited, as with the outline of the waisted shape of the first through portion 101. As described above, in the waisted shape of the second through portion 102, the position at which the width is smallest is not particularly limited.

The cross-sectional shapes of the first through portion 101 and the second through portion 102 may be the same or different.

In the capacitor element 1A, it is preferable that the number of first through portions 101 be two or more, and that the number of second through portions 102 be two or more. The example illustrated in FIG. 1 includes a plurality of first through portions 101 and a plurality of second through portions 102.

In the capacitor element 1A having a plurality of first through portions 101 and a plurality of second through portions 102 in which the widths of both end portions satisfy the above-mentioned relationship, characteristics of the capacitor element 1A are more easily balanced between one main surface side and the other main surface side, so that a warp or the like is even less likely to occur, further reducing the likelihood of the deterioration in the flatness.

It is preferable that the number of first through portions 101 and the number of second through portions 102 be the same in the capacitor element 1A.

However, the number of first through portions 101 and the number of second through portions 102 may be different in the capacitor element 1A. In this case, the number of first through portions 101 may be larger than or smaller than the number of second through portions 102 in the capacitor element 1A.

The number of first through portions 101 in the capacitor element 1A is not limited to two or more, but may be one.

The number of second through portions 102 in the capacitor element 1A is not limited to two or more, but may be one.

In the case in which the capacitor layer 5 includes a plurality of capacitor portions 10 arranged in a plane in the plane directions, the plurality of capacitor portions 10 may include one or more first capacitor portions 11 having the largest areas when viewed in the thickness direction T and one or more second capacitor portions 12 other than the first capacitor portions 11. In the example illustrated in FIG. 1, the capacitor layer 5 includes, as a plurality of capacitor portions 10, one first capacitor portion 11 having the largest area when viewed in the thickness direction T and three second capacitor portions 12 other than the first capacitor portion 11.

The number of first capacitor portions 11 in the capacitor layer 5 may be one, or two or more.

The number of second capacitor portions 12 in the capacitor layer 5 may be one, or two or more.

In the case in which the capacitor layer 5 of the capacitor element 1A includes, as a plurality of capacitor portions 10, one or more first capacitor portions 11 and one or more second capacitor portions 12, it is preferable that the total number of first through portions 101 and second through portions 102 located inside each first capacitor portion 11 when viewed in the thickness direction T be larger than the total number of first through portions 101 and second through portions 102 located inside each second capacitor portion 12. In the example illustrated in FIG. 1, the total number of the first through portions 101 and the second through portions 102 located inside the one first capacitor portion 11 (the first capacitor portion 11 at the upper left) is 80, and for each of the three second capacitor portions 12, the total number of first through portions 101 and second through portions 102 located in one second capacitor portion 12 is 40 (in the second capacitor portion 12 at the lower left), 16 (in the second capacitor portion 12 at the upper right), and 8 (in the second capacitor portion 12 at the lower right).

When the total number of first through portions 101 and second through portions 102 mentioned above is counted, the first through portions 101 and the second through portions 102 located inside one capacitor portion 10 are counted. In the example illustrated in FIG. 1, the first through portions 101 and the second through portions 102 located inside one capacitor portion 10 correspond to the through holes described later, extending through the capacitor portion 10 in the thickness direction T and do not include the through slits described later, dividing the plurality of capacitor portions 10 individually.

Since the total number of first through portions 101 and second through portions 102 located inside one capacitor portion 10 satisfies the above-mentioned relationship between the first capacitor portion 11 and the second capacitor portions 12 in the capacitor element 1A, the first capacitor portion 11, which is considered to tend to warp out of the plurality of capacitor portions 10 due to its large area, has larger numbers of first through portions 101 and second through portions 102, so that the deterioration in the flatness of the first capacitor portion 11 can be efficiently mitigated.

However, the total number of first through portions 101 and second through portions 102 located inside each first capacitor portion 11 may also be the same as or smaller than the total number of first through portions 101 and second through portions 102 located inside each second capacitor portion 12.

The number of first through portions 101 in one capacitor portion 10 may be one, or two or more.

The number of second through portions 102 in one capacitor portion 10 may be one, or two or more.

It is preferable that the number of first through portions 101 and the number of second through portions 102 in one capacitor portion 10 be the same.

However, the number of first through portions 101 and the number of second through portions 102 in one capacitor portion 10 may be different. In this case, the number of first through portions 101 may be larger than or smaller than the number of second through portions 102 in one capacitor portion 10.

In the following, specific configurations of the first through portion 101 and the second through portion 102 will be described.

At least one of the sets of the first through portions 101 and the second through portions 102 may be composed of through holes in the form of holes when viewed in the thickness direction T.

One or both of the sets of the first through portions 101 and the second through portions 102 may be composed of through holes.

In the case in which at least one of the sets of the first through portions 101 and the second through portions 102 is composed of through holes, and hence, for example, the capacitor element 1A has a plurality of through holes, it is easy to arrange through portions, which are through holes, throughout the entire area of the capacitor element 1A, and this makes it easy to mitigate the deterioration of the flatness of the capacitor element 1A as a whole.

In addition, in the case in which at least one of the sets of the first through portions 101 and the second through portions 102 is composed of through holes, and hence, for example, the capacitor element 1A has a plurality of through holes, it is easy to arrange through portions, which are through holes, locally in the capacitor element 1A, and this makes it easy to locally mitigate the deterioration of the flatness of the capacitor element 1A.

In the case in which at least one of the sets of the first through portions 101 and the second through portions 102 is composed of through holes, the width of an end portion of a through portion formed as a through hole (for example, the width W1a, the width W1b, the width W2a, and the width W2b in FIGS. 2 and 3) is defined by the equivalent circle diameter of the end portion when viewed in the thickness direction T.

In the case in which the first through portions 101 and the second through portions 102 are through holes, and both the number of first through portions 101 formed as through holes and the number of second through portions 102 formed as through holes are two or more, the first through portions 101 and the second through portions 102 may be arranged in a lattice shape (in a matrix), in a staggered manner, or in another arrangement other than these, when viewed in the thickness direction T.

In the case in which the first through portions 101 and the second through portions 102 are through holes, and both the number of first through portions 101 formed as through holes and the number of second through portions 102 formed as through holes are two or more, it is preferable that the first through portions 101 and the second through portions 102 be arranged regularly when viewed in the thickness direction T such that the center-to-center distance (pitch) of through portions adjacent in a plane direction is constant throughout the entire area.

However, the first through portions 101 and the second through portions 102 may be arranged irregularly when viewed in the thickness direction T such that the center-to-center distance between through portions adjacent in a plane direction is not constant at least in part.

In the case in which the first through portions 101 and the second through portions 102 are through holes, both the number of first through portions 101 formed as through holes and the number of the second through portions 102 formed as through holes are two or more, it is preferable that the center-to-center distance between first and second through portions 101 and 102 adjacent in a plane direction be smaller than the center-to-center distance between first through portions 101 adjacent in a plane direction, when viewed in the thickness direction T.

However, the center-to-center distance between first and second through portions 101 and 102 adjacent in a plane direction may also be the same as or larger than the center-to-center distance between first through portions 101 adjacent in a plane direction, when viewed in the thickness direction T.

In the case in which the first through portions 101 and the second through portions 102 are through holes, and both the number of first through portions 101 formed as through holes and the number of second through portions 102 formed as through holes are two or more, it is preferable that the center-to-center distance between first and second through portions 101 and 102 adjacent in a plane direction be smaller than the center-to-center distance between second through portions 102 adjacent in a plane direction, when viewed in the thickness direction T.

However, it is preferable that the center-to-center distance between first and second through portions 101 and 102 adjacent in a plane direction may also be the same as or larger than the center-to-center distance between second through portions 102 adjacent in a plane direction, when viewed in the thickness direction T.

In the example illustrated in FIG. 1, the plurality of through portions 100 include through holes 70A serving as the first through portions 101 and through holes 70B serving as the second through portions 102.

It is preferable that the through holes 70A extend through the capacitor portions 10 in the thickness direction T. In the example illustrated in FIGS. 2 and 3, the through holes 70A extend through not only the capacitor portion 10 but also the sealing layers 60, more specifically, the first insulation portion 61, the second insulation portion 62, the fifth insulation portion 65, and the sixth insulation portion 66 in the thickness direction T.

It is preferable that the through holes 70B extend through the capacitor portions 10 in the thickness direction T. In the example illustrated in FIGS. 2 and 3, the through holes 70B extend through not only the capacitor portion 10 but also the sealing layers 60, more specifically, the first insulation portion 61, the second insulation portion 62, the fifth insulation portion 65, and the sixth insulation portion 66 in the thickness direction T.

It is preferable that the capacitor element 1A further include through conductors 71A provided on at least the inner wall surfaces of the through holes 70A.

The through conductors 71A may be provided on the inner wall surfaces of the through holes 70A or may be provided throughout the entire inside of the through holes 70A.

It is preferable that the capacitor element 1A further include through conductors 71B provided on at least the inner wall surfaces of the through holes 70B.

The through conductors 71B may be provided on the inner wall surfaces of the through holes 70B or may be provided throughout the entire inside of the through holes 70B.

In the case in which the through conductors 71A are provided on the inner wall surfaces of the through holes 70A, it is preferable that the thickness of each through conductor 71A be constant regardless of the position in the thickness direction T.

In the case in which the through conductors 71B are provided on the inner wall surfaces of the through holes 70B, it is preferable that the thickness of each through conductor 71B be constant regardless of the position in the thickness direction T.

In the case in which the thickness of each through conductor 71A is constant regardless of the position in the thickness direction T, the volume of the through conductor 71A provided in one through hole 70A is larger in the region around the end portion of the through hole 70A on the first insulation portion 61 side than in the region around the end portion of the through hole 70A on the second insulation portion 62 side. In the case in which the thickness of each through conductor 71B is constant regardless of the position in the thickness direction T, the volume of the through conductor 71B provided in one through hole 70B is smaller in the region around the end portion of the through hole 70B on the first insulation portion 61 side than in the region around the end portion of the through hole 70B on the second insulation portion 62 side. Hence, in the case in which the capacitor element 1A includes the through holes 70A each having a through conductor 71A with a constant thickness regardless of the position in the thickness direction T and the through holes 70B each having a through conductor 71B with a constant thickness regardless of the position in the thickness direction T, the volume of the through conductors is easily balanced between one main surface (in FIGS. 2 and 3, the main surface on the first insulation portion 61 side) side of the capacitor element 1A and the other main surface (in FIGS. 2 and 3, the main surface on the second insulation portion 62 side) side. Hence, the heat dissipation characteristics of the capacitor element 1A that tend to be affected by the volume of through conductors is easily balanced between one main surface side of the capacitor element 1A and the other main surface side, and this makes it easy to achieve heat dissipation characteristics equal on both main surface sides of the capacitor element 1A.

It is preferable that the through conductors 71A be composed of a metal plating material.

It is preferable that the through conductors 71B be composed of a metal plating material.

In the case in which the through conductors 71A and the through conductors 71B are composed of metal plating materials, the heat dissipation characteristics of the capacitor element 1A are more likely to be high. Hence, in the case in which the thickness of the through conductors 71A is constant regardless of the position in the thickness direction T, and the thickness of the through conductors 71B is constant regardless of the position in the thickness direction T, as described above, the heat dissipation characteristics of the capacitor element 1A on both main surface sides are more likely to be high and equal.

It is preferable that the metal plating material be a metal material containing a low resistance metal such as copper, gold, and silver.

The through conductors 71A and the through conductors 71B may be composed of the same metal plating material or may be composed of different metal plating materials.

In the present specification, the expression “a plurality of through conductors are composed of the same metal plating material” denotes that at least the kind of metal plating material is the same in the constituent materials of the plurality of through conductors, and denotes that the ratio of the metal plating material content to the entire constituent material of the through conductor is preferably the same, in addition to the kind of metal plating material.

In the present specification, the expression “a plurality of through conductors are composed of different metal plating materials or partially composed of different metal plating materials” denotes that at least the kind of metal plating material is different or partially different between the constituent materials of the plurality of through conductors, and denotes that the ratio of the metal plating material content to the entire constituent material of the through conductor is preferably different or partially different, in addition to the kind of metal plating material.

Examples of the planar shapes of the through hole 70A and the through hole 70B viewed in the thickness direction T include circular shapes, elliptical shapes, and rectangular shapes (squares or rectangles).

The planar shapes of the through hole 70A and the through hole 70B may be the same or may be different.

In the case in which the first through portions 101 and the second through portions 102 are through holes, and through conductors are provided on at least the inner wall surfaces of these through holes, the through conductors provided on one of the sets of the first through portions 101 and the second through portions 102 may be electrically connected to the anode layer 20, and the through conductors of the other of the sets of the first through portions 101 and the second through portions 102 may be electrically connected to the cathode layers 40.

In the example illustrated in FIGS. 2 and 3, the through conductors 71A provided on the inner wall surfaces of the through holes 70A serving as the first through portions 101 are electrically connected to the anode layer 20.

An example of a configuration in which the through conductors 71A are electrically connected to the anode layer 20 will be described below.

It is preferable that each through conductor 71A be electrically connected to the end surface of the anode layer 20 facing the inner wall surface of the through hole 70A in the plane directions.

It is preferable that the core portion 21 and the porous portions 22 be exposed on the end surface of the anode layer 20 electrically connected to the through conductor 71A. In this case, in addition to the core portion 21, the porous portions 22 are electrically connected to the through conductor 71A.

It is preferable that the through conductor 71A be electrically connected to the anode layer 20 over the entire periphery of the through hole 70A when viewed in the thickness direction T. In this case, the connection resistance between the anode layer 20 and the through conductor 71A is more likely to be low, and the equivalent series resistance (ESR) of the capacitor portions 10 (the capacitor layer 5) is more likely to be low.

The through holes 70A and the through conductors 71A are formed, for example, as described below. First, the through holes 70A are formed to extend through the capacitor portion 10 and the sealing layers 60 in the thickness direction T by laser processing or the like. Then, the inner wall surfaces of the through holes 70A are metallized with a metal material containing a low resistance metal such as copper, gold, and silver to form through conductors 71A. When forming the through conductors 71A, for example, metallizing the inner wall surfaces of the through holes 70A by electroless copper plating, electrolytic copper plating, or the like makes the processing easy. Regarding the method of forming the through conductors 71A, a method in which the through holes 70A are filled with a metal material, a composite material containing a metal and a resin, or the like may be used, instead of the method in which the inner wall surfaces of the through holes 70A are metallized.

The capacitor element 1A preferably further includes an anode connection layer 72 located between the anode layer 20 and each through conductor 71A in the plane directions. In the example illustrated in FIGS. 2 and 3, the anode connection layer 72 is in contact with both the anode layer 20 and the through conductor 71A.

Since the anode connection layer 72 is located between the anode layer 20 and the through conductor 71A in the plane directions, the anode connection layer 72 functions as a barrier layer for the anode layer 20, more specifically, a barrier layer for the core portion 21 and the porous portions 22. In the case in which the anode connection layer 72 functions as a barrier layer for the anode layer 20, dissolution of the anode layer 20 that occurs during a chemical treatment to form outer electrode layers 80A described later and the like is reduced, in other words, infiltration of chemicals into the capacitor portion 10 is reduced, which makes it easier to improve the reliability of the capacitor element 1A.

The dimension of the anode connection layer 72 in the thickness direction T is preferably larger than the dimension of the anode layer 20 in the thickness direction T. In this case, since the entire end surface of the anode layer 20 is covered with the anode connection layer 72, the barrier property of the anode connection layer 72 for the anode layer 20 is more likely to be high.

It is preferable that the dimension of the anode connection layer 72 in the thickness direction T be greater than 100% and not greater than 200% of the dimension of the anode layer 20 in the thickness direction T.

However, the dimension of the anode connection layer 72 in the thickness direction T may be the same as or smaller than the dimension of the anode layer 20 in the thickness direction T.

It is preferable that the through conductor 71A be connected to the anode connection layer 72 over the entire periphery of the through hole 70A when viewed in the thickness direction T. In this case, the contact area between the through conductor 71A and the anode connection layer 72 is large, and thus the connection resistance between the through conductor 71A and the anode connection layer 72 is more likely to be low. Hence, the connection resistance between the anode layer 20 and the through conductor 71A is more likely to be low, and thus the equivalent series resistance of the capacitor portions 10 (the capacitor layer 5) is more likely to be low. In addition, because the adhesion between the through conductor 71A and the anode connection layer 72 is more likely to be high, defects such as a separation between the through conductor 71A and the anode connection layer 72 due to thermal stress are less likely to occur.

It is preferable that the anode connection layer 72 include a layer containing nickel as a main component. In this case, damage to the metal (for example, aluminum) and the like composing the anode layer 20 is reduced, and this makes it easy to improve the barrier property of the anode connection layer 72 for the anode layer 20.

With the configuration described above, in the example illustrated in FIGS. 2 and 3, the through conductor 71A is electrically connected to the anode layer 20 with the anode connection layer 72 interposed therebetween.

However, a configuration without the anode connection layer 72 between the anode layer 20 and the through conductor 71A in the plane directions is also possible. In this case, the through conductor 71A may be directly connected to the end surface of the anode layer 20.

The capacitor element 1A preferably includes the outer electrode layers 80A electrically connected to the through conductors 71A. In the example illustrated in FIGS. 2 and 3, the outer electrode layers 80A are located on the surfaces of the through conductors 71A and function as connection terminals of the capacitor element 1A (the capacitor layer 5 and the capacitor portions 10). In the example illustrated in FIGS. 2 and 3, the outer electrode layers 80A are electrically connected to the anode layer 20 with the through conductors 71A interposed therebetween and function as connection terminals for the anode layer 20.

The outer electrode layer 80A may be provided on at least one main surface of the sealing layers 60.

Specifically, the outer electrode layer 80A may be provided only on one main surface of the sealing layers 60 (in FIGS. 2 and 3, the main surface on the first insulation portion 61 side or the main surface on the second insulation portion 62 side) or may be provided on both main surfaces of the sealing layers 60 (in FIGS. 2 and 3, the main surface on the first insulation portion 61 side and the main surface on the second insulation portion 62 side).

Examples of the constituent material of the outer electrode layer 80A include a metal material containing a low resistance metal such as silver, gold, and copper. In this case, the outer electrode layers 80A are formed, for example, by plating the surfaces of the through conductors 71A.

To improve the adhesion between the outer electrode layer 80A and another member, in this case, the adhesion between the outer electrode layer 80A and the through conductor 71A, a mixed material of a resin and at least one kind of conductive fillers selected from the group of silver fillers, copper fillers, nickel fillers, and carbon fillers may be used as the constituent material of the outer electrode layer 80A.

The capacitor element 1A preferably further includes resin-filled portions 90A formed by filling the through holes 70A with a resin material. In the example illustrated in FIGS. 2 and 3, the resin-filled portion 90A is located in the space surrounded by the through conductor 71A on the inner wall surface of the through hole 70A. Since the presence of the resin-filled portion 90A eliminates the space in the through hole 70A, it reduces the occurrence of delamination of the through conductor 71A.

It is preferable that the coefficient of thermal expansion of the resin-filled portion 90A be higher than the coefficient of thermal expansion of the through conductor 71A. More specifically, it is preferable that the coefficient of thermal expansion of the resin material filling the through hole 70A be higher than the coefficient of thermal expansion of the constituent material of the through conductor 71A (for example, copper). In this case, the resin-filled portion 90A, more specifically, the resin material filling the through hole 70A, expands under high temperature environment, and the through conductor 71A is pressed against the inner wall surface of the through hole 70A from the inside toward the outside of the through hole 70A. This sufficiently reduces the occurrence of delamination of the through conductor 71A.

However, the coefficient of thermal expansion of the resin-filled portion 90A may be the same as or lower than the coefficient of thermal expansion of the through conductor 71A. More specifically, the coefficient of thermal expansion of the resin material filling the through hole 70A may be the same as or lower than the coefficient of thermal expansion of the constituent material of the through conductor 71A.

However, the capacitor element 1A may have a configuration without the resin-filled portions 90A. In this case, it is preferable that the through conductors 71A be located not only on the inner wall surfaces of the through holes 70A but throughout the entire inside of the through holes 70A.

In the example illustrated in FIGS. 2 and 3, the through conductors 71B provided on the inner wall surfaces of the through holes 70B serving as the second through portions 102 are electrically connected to the cathode layers 40.

An example of a configuration in which the through conductors 71B are electrically connected to the cathode layers 40 will be described below.

The through holes 70B and the through conductors 71B are formed, for example, as described below. First, through holes are formed to extend through the capacitor portion 10 in the thickness direction T by laser processing or the like. Next, the capacitor layer 5 is sealed from both main surface sides by using an insulating material to form at least the first insulation portion 61 that covers one main surface of the capacitor layer 5, the second insulation portion 62 that covers the other main surface of the capacitor layer 5, and the third insulation portions 63 that fills the above-mentioned through holes. In this process, the fifth insulation portion 65 adjoining the side of the first insulation portion 61 opposite to the capacitor layer 5 and the sixth insulation portion 66 adjoining the side of the second insulation portion 62 opposite to the capacitor layer 5 may be formed as necessary. Then, laser processing is performed on the third insulation portions 63 (also on the fifth insulation portion 65 and the sixth insulation portion 66 if these are formed) to form the through holes 70B. In this process, the diameter of the through hole 70B is set to be smaller than the diameter of the previously formed through hole, so that the third insulation portion 63 remains between the inner wall surface of the previously formed through hole and the inner wall surface of the through hole 70B in the plane directions. After that, the inner wall surfaces of the through holes 70B are metallized with a metal material containing a low resistance metal such as copper, gold, and silver to form the through conductors 71B. When forming the through conductors 71B, for example, metallizing the inner wall surfaces of the through holes 70B by electroless copper plating, electrolytic copper plating, or the like makes the processing easy. Regarding the method of forming the through conductors 71B, a method in which the through holes 70B are filled with a metal material, a composite material containing a metal and a resin, or the like may be used, instead of the method in which the inner wall surfaces of the through holes 70B are metallized.

In the case in which the through hole 70B is formed to extend through the third insulation portion 63 in the thickness direction T, and the through conductor 71B is provided on the inner wall surface of the through hole 70B, as described above, the third insulation portion 63 is located between the capacitor portion 10 and the through conductor 71B, in other words, between the anode layer 20 and the through conductor 71B, in the plane directions. In the example illustrated in FIGS. 2 and 3, the third insulation portion 63 is in contact with both the capacitor portion 10 and the through conductor 71B, in other words, both the anode layer 20 and the through conductor 71B.

Since the third insulation portion 63 is located between the capacitor portion 10 and the through conductor 71B, in other words, between the anode layer 20 and the through conductor 71B, in the plane directions, the insulation between the anode layer 20 and the through conductor 71B, in other words, the insulation between the anode layer 20 and the cathode layers 40, can be achieved, which prevents a short circuit between them.

In the case in which the third insulation portion 63 is contact with both the capacitor portion 10 and the through conductor 71B, in other words, both the anode layer 20 and the through conductor 71B, it is preferable that the core portion 21 and the porous portions 22 be exposed on the end surface of the anode layer 20 in contact with the third insulation portion 63. In this case, the contact area between the porous portions 22 and the third insulation portion 63 is large, which improves the adhesion between them, so that defects such as a separation between the porous portions 22 and the third insulation portion 63 are less likely to occur.

In the case in which the core portion 21 and the porous portions 22 are exposed on the end surface of the anode layer 20 in contact with the third insulation portion 63, it is preferable that the mask layer 50, which is formed to extend inside the porous portion 22 by the constituent material of the mask layer 50 infiltrating into the pores of the porous portion 22, be located around the through conductor 71B. In this case, the insulation between the anode layer 20 and the through conductor 71B, in other words, the insulation between the anode layer 20 and the cathode layers 40 can be sufficiently achieved, which sufficiently prevents a short circuit between them.

In the case in which the core portion 21 and the porous portions 22 are exposed on the end surface of the anode layer 20 in contact with the third insulation portion 63, it is preferable that the insulating material composing the third insulation portion 63 infiltrate into the pores of the porous portion 22. This improves the mechanical strength of the porous portions 22, reducing the occurrence of delamination resulting from the pores of the porous portions 22.

It is preferable that the coefficient of thermal expansion of the third insulation portion 63 be higher than the coefficient of thermal expansion of the through conductor 71B. More specifically, it is preferable that the coefficient of thermal expansion of the insulating material composing the third insulation portion 63 be higher than the coefficient of thermal expansion of the constituent material of the through conductor 71B (for example, copper). In this case, the third insulation portion 63, more specifically, the insulating material composing the third insulation portion 63, expands under high temperature environment, pressing the porous portions 22 and the through conductor 71B. This sufficiently reduces the occurrence of delamination.

However, the coefficient of thermal expansion of the third insulation portion 63 may be the same as or lower than the coefficient of thermal expansion of the through conductor 71B. More specifically, the coefficient of thermal expansion of the insulating material composing the third insulation portion 63 may be the same as or lower than the coefficient of thermal expansion of the constituent material of the through conductor 71B.

The capacitor element 1A preferably includes outer electrode layers 80B electrically connected to the through conductors 71B. In the example illustrated in FIGS. 2 and 3, the outer electrode layers 80B are located on the surfaces of the through conductors 71B and function as connection terminals of the capacitor element 1A (the capacitor layer 5 and the capacitor portions 10).

The outer electrode layer 80B may be provided on at least one main surface of the sealing layers 60. Specifically, the outer electrode layer 80B may be provided only on one main surface of the sealing layers 60 (in FIGS. 2 and 3, the main surface on the first insulation portion 61 side or the main surface on the second insulation portion 62 side) or may be provided on both main surfaces of the sealing layers 60 (in FIGS. 2 and 3, the main surface on the first insulation portion 61 side and the main surface on the second insulation portion 62 side).

Examples of the constituent material of the outer electrode layer 80B include a metal material containing a low resistance metal such as silver, gold, and copper. In this case, the outer electrode layers 80B are formed, for example, by plating the surfaces of the through conductors 71B.

To improve the adhesion between the outer electrode layer 80B and another member, in this case, the adhesion between the outer electrode layer 80B and the through conductor 71B, a mixed material of a resin and at least one kind of conductive fillers selected from the group of silver fillers, copper fillers, nickel fillers, and carbon fillers may be used as the constituent material of the outer electrode layer 80B.

It is preferable that the constituent materials of the outer electrode layer 80A and the outer electrode layer 80B be the same at least in terms of kind, but they may be different.

The outer electrode layer 80A and the outer electrode layer 80B may be provided on the same main surface side of the sealing layers 60. In other words, the outer electrode layer 80A and the outer electrode layer 80B may be provided on the same one main surface side of the sealing layers 60 or may be provided on both main surface sides of the sealing layers 60.

The outer electrode layer 80A and the outer electrode layer 80B may be provided on different main surface sides of the sealing layers 60. In other words, one of the outer electrode layer 80A and the outer electrode layer 80B may be provided on one main surface side of the sealing layers 60, and the other may be provided on the other main surface side of the sealing layers 60.

In the case in which the capacitor layer 5 includes a plurality of capacitor portions 10, at least one of the outer electrode layer 80A and the outer electrode layer 80B may be provided individually for each of the capacitor portions 10 or may be provided to be shared by all the capacitor portions 10.

The capacitor element 1A preferably further includes via conductors 73 penetrating into the sealing layers 60 in the thickness direction T and connected to the cathode layers 40 and the outer electrode layers 80B. In the example illustrated in FIGS. 2 and 3, some of the via conductors 73 pass through the first insulation portion 61 and the fifth insulation portion 65 in the thickness direction T and are connected to the cathode layer 40 and the outer electrode layer 80B. In addition, in the example illustrated in FIGS. 2 and 3, the other via conductors 73 pass through the second insulation portion 62 and the sixth insulation portion 66 in the thickness direction T and are connected to the cathode layer 40 and the outer electrode layer 80B.

Examples of the constituent material of the via conductors 73 include a metal material containing a low resistance metal such as silver, gold, and copper.

The via conductors 73 are formed, for example, by plating the inner wall surfaces of through holes, which extend through the first insulation portion 61 and the fifth insulation portion 65 in the thickness direction T, with a foregoing metal material, or by filling the through holes with a conductive paste and then performing a heat treatment.

With the configuration described above, in the example illustrated in FIGS. 2 and 3, the through conductors 71B are electrically connected to the cathode layers 40 with the outer electrode layers 80B and the via conductors 73 interposed therebetween.

In the example illustrated in FIGS. 2 and 3, the outer electrode layers 80B are electrically connected to the cathode layers 40 with the via conductors 73 interposed therebetween and function as the connection terminals for the cathode layers 40.

The capacitor element 1A preferably further includes resin-filled portions 90B formed by filling the through holes 70B with a resin material. In the example illustrated in FIGS. 2 and 3, the resin-filled portion 90B is located in the space surrounded by the through conductor 71B on the inner wall surface of the through hole 70B. Since the presence of the resin-filled portion 90B eliminates the space in the through hole 70B, it reduces the occurrence of delamination of the through conductor 71B.

It is preferable that the coefficient of thermal expansion of the resin-filled portion 90B be higher than the coefficient of thermal expansion of the through conductor 71B. More specifically, it is preferable that the coefficient of thermal expansion of the resin material filling the through hole 70B be higher than the coefficient of thermal expansion of the constituent material of the through conductor 71B (for example, copper). In this case, the resin-filled portion 90B, more specifically, the resin material filling the through hole 70B, expands under high temperature environment, and the through conductor 71B is pressed against the inner wall surface of the through hole 70B from the inside toward the outside of the through hole 70B. This sufficiently reduces the occurrence of delamination of the through conductor 71B.

However, the coefficient of thermal expansion of the resin-filled portion 90B may be the same as or lower than the coefficient of thermal expansion of the through conductor 71B. More specifically, the coefficient of thermal expansion of the resin material filling the through hole 70B may be the same as or lower than the coefficient of thermal expansion of the constituent material of the through conductor 71B.

However, the capacitor element 1A may have a configuration without the resin-filled portions 90B. In this case, it is preferable that the through conductors 71B be located not only on the inner wall surfaces of the through holes 70B but throughout the entire inside of the through holes 70B.

As described above, in the example illustrated in FIGS. 2 and 3, the through conductors 71A provided on the inner wall surfaces of the through holes 70A serving as the first through portions 101 are electrically connected to the anode layer 20, and the through conductors 71B provided on the inner wall surfaces of the through holes 70B serving as the second through portions 102 are electrically connected to the cathode layers 40.

In the example illustrated in FIGS. 2 and 3, when the through holes 70A serving as the first through portions 101 and the through holes 70B serving as the second through portions 102 are formed by an above-mentioned method, the through holes 70A and the through holes 70B can be formed efficiently by, for example, performing laser processing on the capacitor layer 5 and the sealing layers 60 from the first insulation portion 61 side when forming the through holes 70A and performing laser processing on the capacitor layer 5 and the sealing layers 60 from the second insulation portion 62 side when forming the through holes 70B.

Unlike the example illustrated in FIGS. 2 and 3, the through conductors 71A provided on the inner wall surfaces of the through holes 70A serving as the first through portions 101 may be electrically connected to the cathode layers 40, and the through conductors 71B provided on the inner wall surfaces of the through holes 70B serving as the second through portions 102 may be electrically connected to the anode layer 20.

As described above, in the capacitor element 1A, the first through portions 101 and the second through portions 102 function as through holes for providing through conductors electrically connected to different electrode layers (the anode layer 20 and the cathode layers 40). This ensures the ease of designing the capacitor element 1A.

However, to ensure the ease of designing the capacitor element 1A, the first through portions 101 and the second through portions 102 may function as through holes for providing through conductors electrically connected to the same electrode layer(s) (the anode layer 20 or the cathode layers 40). Such a specific example will be described below.

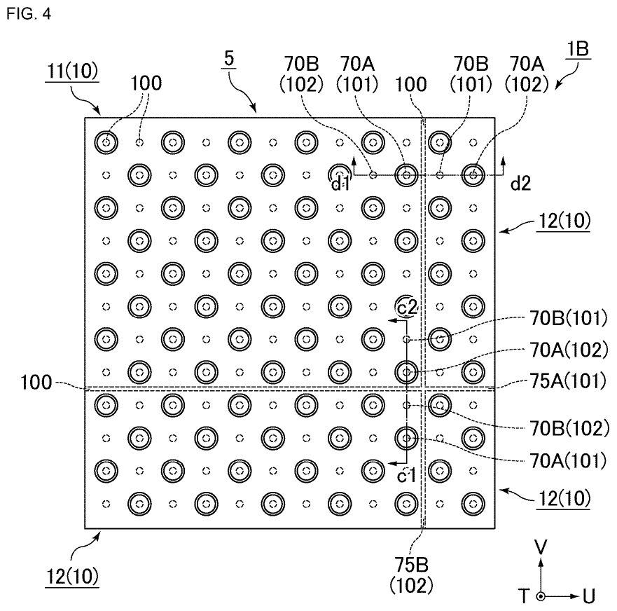

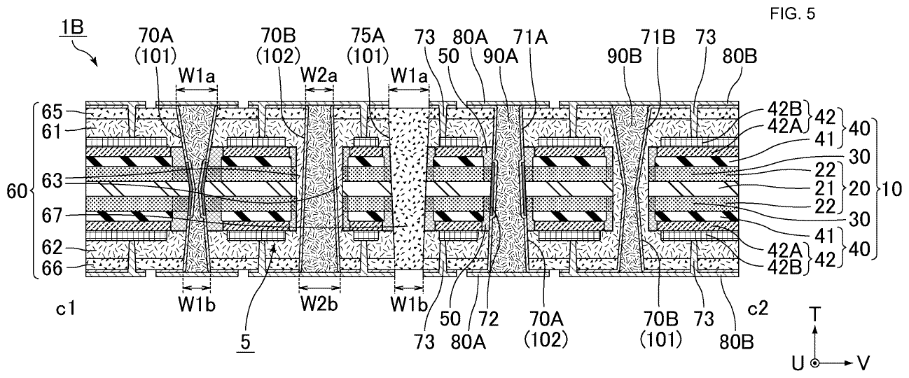

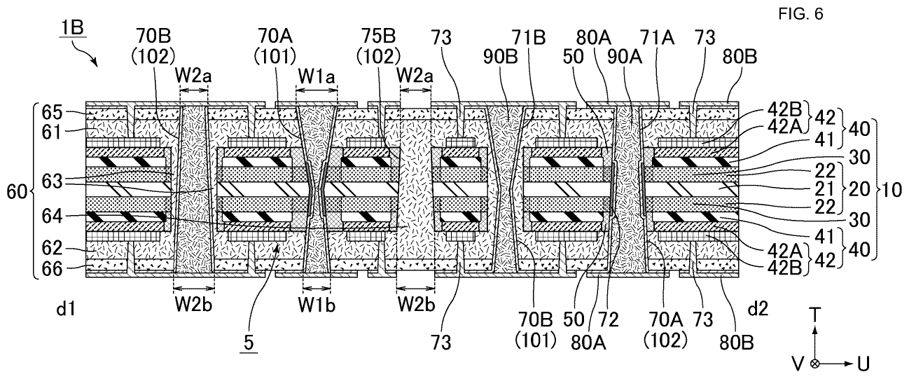

FIG. 4 is a schematic plan view of another example of a capacitor element of the present disclosure. FIG. 5 is a schematic cross-sectional view of an example of a cross section of the capacitor element illustrated in FIG. 4, taken along line segment c1-c2. FIG. 6 is a schematic cross-sectional view of an example of a cross section of the capacitor element illustrated in FIG. 4, taken along line segment d1-d2.

In the capacitor element 1B illustrated in FIGS. 4 to 6, in the case in which the first through portions 101 and the second through portions 102 are through holes, and through conductors are provided on at least the inner wall surfaces of these through holes, the through conductors provided in the first through portions 101 and the second through portions 102 may be electrically connected to the anode layer 20.

In the example illustrated in FIGS. 5 and 6, the through conductors 71A (in FIGS. 5 and 6, the through conductor 71A on the left side) provided on the inner wall surfaces of the through holes 70A (in FIGS. 5 and 6, the through hole 70A on the left side) serving as the first through portions 101 and the through conductors 71A (in FIGS. 5 and 6, the through conductor 71A on the right side) provided on the inner wall surfaces of the through holes 70A (in FIGS. 5 and 6, the through hole 70A on the right side) serving as the second through portions 102 are electrically connected to the anode layer 20.

In the capacitor element 1B illustrated in FIGS. 4 to 6, in the case in which the first through portions 101 and the second through portions 102 are through holes, and through conductors are provided on at least the inner wall surfaces of these through holes, the through conductors provided in the first through portions 101 and the second through portions 102 may be electrically connected to the cathode layers 40.

In the example illustrated in FIGS. 5 and 6, the through conductors 71B (in FIGS. 5 and 6, the through conductor 71B on the right side) provided on the inner wall surfaces of the through holes 70B (in FIGS. 5 and 6, the through hole 70B on the right side) serving as the first through portions 101 and the through conductors 71B (in FIGS. 5 and 6, the through conductor 71B on the left side) provided on the inner wall surfaces of the through holes 70B (in FIGS. 5 and 6, the through hole 70B on the left side) serving as the second through portions 102 are electrically connected to the cathode layers 40.

Although the description above is based on a configuration in which at least one of the sets of the first through portions 101 and the second through portions 102 is composed of through holes, the first through portions 101 and the second through portions 102 are not limited to through holes.

At least one of the sets of the first through portions 101 and the second through portions 102 may be composed of through slits in the form of slits when viewed in the thickness direction T.

One or both of the sets of the first through portions 101 and the second through portions 102 may be composed of through slits.

In the case in which at least one of the sets of the first through portions 101 and the second through portions 102 is composed of through slits, it is easy to arrange through portions formed as through slits in a wide range in the capacitor element 1A and the capacitor element 1B, which makes it easy to mitigate the deterioration in the flatness of the capacitor element 1A and the capacitor element 1B in a wide range.

In the case in which at least one of the sets of the first through portions 101 and the second through portions 102 is composed of through slits, the width of an end portion of the through portion formed as a through slit (for example, the width W1a, the width W1b, the width W2a, and the width W2b in FIGS. 2, 3, 5, and 6) is defined by the dimension of the end portion in a direction, out of the plane directions, perpendicular to the direction in which the through portion (the through slit) extends (for example, the first direction U or the second direction V in FIGS. 1 and 4).

In the examples illustrated in FIGS. 1 and 4, the plurality of through portions 100 include a through slit 75A serving as a first through portion 101 and a through slit 75B serving as a second through portion 102.

In the case in which the capacitor layer 5 includes a plurality of capacitor portions 10 arranged in a plane in the plane directions, it is preferable that the through slit 75A divide the plurality of capacitor portions 10 individually. In the examples illustrated in FIGS. 1 and 4, the through slit 75A individually divides two capacitor portions 10 arranged in a plane in the second direction V (the combination of the first capacitor portion 11 at the upper left and the second capacitor portion 12 at the lower left, or the combination of the second capacitor portion 12 at the upper right and the second capacitor portion 12 at the lower right).

In the examples illustrated in FIGS. 2 and 5, the through slit 75A passes through not only the capacitor layer 5 (the capacitor portions 10) but also the sealing layers 60, more specifically, the first insulation portion 61 and the second insulation portion 62, in the thickness direction T. Hence, the end portion of the through slit 75A on the first insulation portion 61 side is defined not at the same position in the through slit 75A as the position of one main surface of the capacitor layer 5 (the capacitor portions 10) but at the same position as the position of the surface of the first insulation portion 61 opposite to the capacitor layer 5 (the capacitor portions 10). The end portion of the through slit 75A on the second insulation portion 62 side is defined not at the same position in the through slit 75A as the position of the other main surface of the capacitor layer 5 (the capacitor portions 10) but at the same position as the position of the surface of the second insulation portion 62 opposite to the capacitor layer 5 (the capacitor portions 10).

It is preferable that the inside of the through slit 75A be filled with an insulating material. In the examples illustrated in FIGS. 2 and 5, the inside of the through slit 75A is filled with an insulating material composing the seventh insulation portion 67.

The through slit 75A filled with an insulating material is formed, for example, as described below. First, the capacitor layer 5 (in the case of forming the through slit 75B as described later, in the state in which the through slit 75B is formed) is sealed from both main surface sides by using an insulating material to form at least the first insulation portion 61 that covers one main surface of the capacitor layer 5 and the second insulation portion 62 that covers the other main surface of the capacitor layer 5. Next, laser processing or the like is performed on the capacitor layer 5, the first insulation portion 61, and the second insulation portion 62 to form the through slit 75A. Then, the capacitor layer 5, the first insulation portion 61, and the second insulation portion 62 are sealed from both main surface sides by using an insulating material to form the seventh insulation portion 67 filling the through slit 75A. Thus, the through slit 75A filled with the insulating material composing the seventh insulation portion 67 is formed.

The through slit 75A, when viewed in the thickness direction T, may extend in a straight line, a curved line, or a line including a straight line and a curved line.

The through slit 75A, when viewed in the thickness direction T, may extend in one direction or may be bent at an intermediate position and extend in a plurality of directions.

In the case in which the capacitor layer 5 includes a plurality of capacitor portions 10 arranged in a plane in the plane directions, it is preferable that the through slit 75B divide the plurality of capacitor portions 10 individually. In the examples illustrated in FIGS. 1 and 4, the through slit 75B individually divides two capacitor portions 10 arranged in a plane in the first direction U (the combination of the first capacitor portion 11 at the upper left and the second capacitor portion 12 at the upper right, or the combination of the second capacitor portion 12 at the lower left and the second capacitor portion 12 at the lower right).

In the examples illustrated in FIGS. 3 and 6, the through slit 75B passes through the capacitor layer 5 (the capacitor portions 10) in the thickness direction T. Hence, the end portion of the through slit 75B on the first insulation portion 61 side is defined at the same position in the through slit 75B as the position of one main surface of the capacitor layer 5 (the capacitor portions 10). The end portion of the through slit 75B on the second insulation portion 62 side is defined at the same position in the through slit 75B as the position of the other main surface of the capacitor layer 5 (the capacitor portions 10).

It is preferable that the inside of the through slit 75B be filled with an insulating material. In the examples illustrated in FIGS. 3 and 6, the inside of the through slit 75B is filled with an insulating material composing the fourth insulation portion 64.

The through slit 75B filled with an insulating material is formed, for example, as described below. First, laser processing or the like is performed on the capacitor layer 5 (in the case in which the capacitor layer 5 includes a plurality of capacitor portions 10, in the state of a capacitor sheet before being divided into individual capacitor portions 10) to form the through slit 75B. Then, the capacitor layer 5 is sealed from both main surface sides by using an insulating material to form at least the first insulation portion 61 that covers one main surface of the capacitor layer 5, the second insulation portion 62 that covers the other main surface of the capacitor layer 5, and the fourth insulation portion 64 filling the through slit 75B. Thus, the through slit 75B filled with the insulating material composing the fourth insulation portion 64 is formed.

The through slit 75B, when viewed in the thickness direction T, may extend in a straight line, a curved line, or a line including a straight line and a curved line.

The through slit 75B, when viewed in the thickness direction T, may extend in one direction or may be bent at an intermediate position and extend in a plurality of directions.

In the case in which a first through portion 101 and a second through portion 102 are through slits, it is preferable that the first through portion 101 and the second through portion 102 extend in different directions of the plane directions. In the examples illustrated in FIGS. 1 and 4, the through slit 75A serving as a first through portion 101 extends in the first direction U of the plane directions, and the through slit 75B serving as a second through portion 102 extends in the second direction V of the plane directions.

In the case in which the through slit 75A and the through slit 75B extend in different directions of the plane directions, the extending directions are not limited to directions perpendicular to each other (for example, the first direction U and the second direction V) out of the plane directions, but may be directions not perpendicular to each other out of the plane directions.

When the through slit 75A and the through slit 75B extending in different directions of the plane directions are formed by the above-mentioned methods, the through slit 75A and the through slit 75B can be formed efficiently by, for example, performing laser processing on at least the capacitor layer 5 from the first insulation portion 61 side when forming the through slit 75A and performing laser processing on at least the capacitor layer 5 from the second insulation portion 62 side when forming the through slit 75B.

In the capacitor element of the present disclosure, in the case in which the plurality of through portions passing through at least the capacitor layer in the thickness direction include one or more first through portions and one or more second through portions, the plurality of through portions may further include a third through portion having end portions with the same width on the first insulation portion side and the second insulation portion side.

The capacitor element of the present disclosure may further include a fourth through portion passing through the capacitor element in the thickness direction in a region that does not overlap the capacitor layer when viewed in the thickness direction.

In the capacitor element of the present disclosure, the capacitor portion is not limited to electrolytic capacitors including solid electrolytic capacitors mentioned above. In the capacitor element of the present disclosure, the capacitor portions may function as, for example, ceramic capacitors containing barium titanate; thin film capacitors containing silicon nitride (SiN), silicon dioxide (SiO₂), hydrogen fluoride (HF), or the like; trench capacitors having a metal-insulator-metal (MIM) structure; or the like.

In the capacitor element of the present disclosure, to make the capacitor portions thinner and larger in area and to improve the mechanical properties of the capacitor portions such as stiffness and flexibility, it is preferable that the capacitor portions be capacitors containing a metal such as aluminum as a base material, and it is more preferable that the capacitor portions be electrolytic capacitors containing a metal such as aluminum as a base material.

The periphery of the capacitor element of the present disclosure may be further sealed with a resin layer.

The capacitor element of the present disclosure may have, for example, an array arrangement and serve as a capacitor array.

The capacitor element of the present disclosure may be used, for example, in a composite electronic component. Such a composite electronic component includes, for example, a capacitor element of the present disclosure and electronic components electrically connected to outer electrode layers of the capacitor element of the present disclosure.

The electronic components used in the composite electronic component may be passive elements or active elements, may include both passive and active elements, or may be a composite of passive and active elements.

Examples of passive elements include an inductor.

Examples of active elements include a memory, a graphical processing unit (GPU), a central processing unit (CPU), a micro processing unit (MPU), and a power management IC (PMIC).

When the capacitor element of the present disclosure is used in a composite electronic component, the capacitor element of the present disclosure is used, for example, as a substrate for mounting an electronic component. In this case, since the capacitor element of the present disclosure exhibits less deterioration in the flatness as described above, the electronic component can be mounted with high positional accuracy on the capacitor element of the present disclosure. Hence, since the electronic component can be mounted on the connection terminals (for example, the outer electrode layers) of the capacitor element of the present disclosure with high positional accuracy, the electronic component and the anode layer of the capacitor element of the present disclosure can be sufficiently electrically connected, and the electronic component and the cathode layers of the capacitor element of the present disclosure can be sufficiently electrically connected.

In the case in which the capacitor element of the present disclosure is used as a substrate for mounting an electronic component, the capacitor element of the present disclosure is formed in a sheet shape as a whole, and an electronic component to be mounted on the capacitor element of the present disclosure is formed in a sheet shape, so that the capacitor element of the present disclosure and the electronic component can be electrically connected in the thickness direction with through conductors passing through the electronic component in the thickness direction interposed therebetween. This makes it possible to form a module including a passive element and an active element, which are electronic components, all together.

For example, a switching regulator can be formed by electrically connecting a capacitor element of the present disclosure between a voltage regulator including a semiconductor active device and a load to which a direct current voltage generated by conversion is supplied.

In a composite electronic component, a circuit layer may be formed on one main surface of a capacitor matrix sheet in which a plurality of capacitor elements of the present disclosure are laid out, and the circuit layer may be electrically connected to a passive element or an active element, which is an electronic component.

Alternatively, a capacitor element of the present disclosure is placed in a cavity portion formed in advance in a substrate, and the cavity is filled with a resin. Then, a circuit layer may be formed on the resin. A passive element or an active element, which is another electronic component, may be mounted in another cavity portion in the same substrate.

Alternatively, a capacitor element of the present disclosure is mounted on a smooth carrier such as a wafer or a glass. An outer layer portion is formed by using a resin, and then a circuit layer is formed. The circuit layer may be electrically connected to a passive element or an active element, which is an electronic component.

### REFERENCE SIGNS LIST

1A, 1B CAPACITOR ELEMENT
5 CAPACITOR LAYER
10 CAPACITOR PORTION
11 FIRST CAPACITOR PORTION
12 SECOND CAPACITOR PORTION
20 ANODE LAYER
21 CORE PORTION
22 POROUS PORTION
30 DIELECTRIC LAYER
40 CATHODE LAYER
41 SOLID ELECTROLYTE LAYER
42 CONDUCTOR LAYER
42A CONDUCTIVE RESIN LAYER
42B METAL LAYER
50 MASK LAYER
60 SEALING LAYER
61 FIRST INSULATION PORTION
62 SECOND INSULATION PORTION
63 THIRD INSULATION PORTION
64 FOURTH INSULATION PORTION
65 FIFTH INSULATION PORTION
66 SIXTH INSULATION PORTION
67 SEVENTH INSULATION PORTION
70A, 70B THROUGH HOLE
71A, 71B THROUGH CONDUCTOR
72 ANODE CONNECTION LAYER
73 VIA CONDUCTOR
75A, 75B THROUGH SLIT
80A, 80B OUTER ELECTRODE LAYER
90A, 90B RESIN-FILLED PORTION
100 THROUGH PORTION
101 FIRST THROUGH PORTION
102 SECOND THROUGH PORTION
T THICKNESS DIRECTION
U FIRST DIRECTION
V SECOND DIRECTION
W1a WIDTH OF END PORTION OF FIRST THROUGH PORTION ON FIRST INSULATION PORTION SIDE
W1b WIDTH OF END PORTION OF FIRST THROUGH PORTION ON SECOND INSULATION PORTION SIDE
W2a WIDTH OF END PORTION OF SECOND THROUGH PORTION ON FIRST INSULATION PORTION SIDE
W2b WIDTH OF END PORTION OF SECOND THROUGH PORTION ON SECOND INSULATION PORTION SIDE

1. A capacitor element comprising:
a planar capacitor layer parallel to a plane direction perpendicular to a thickness direction and including one or more capacitor portions, wherein the capacitor portions include an anode layer, a dielectric layer, and a cathode layer facing the anode layer with the dielectric layer interposed therebetween in the thickness direction; and
a sealing layer composed of an insulating material and sealing the capacitor layer from two main surface sides of the capacitor layer opposed to each other in the thickness direction, wherein
the sealing layer includes a first insulation portion covering a first main surface of the capacitor layer and a second insulation portion covering a second main surface of the capacitor layer,
at least the capacitor layer includes a plurality of through portions passing through at least the capacitor layer in the thickness direction,
the plurality of through portions include one or more first through portions and one or more second through portions,
a width of an end portion of each of the first through portions on a first insulation portion side is larger than a width of an end portion of each of the first through portions on a second insulation portion side, and
a width of an end portion of each of the second through portions on the first insulation portion side is smaller than a width of an end portion of each of the second through portions on the second insulation portion side.

2. The capacitor element according to claim 1, wherein a number of the first through portions is two or more, and a number of the second through portions is two or more.

3. The capacitor element according to claim 1, wherein
the capacitor layer includes a plurality of the capacitor portions arranged in a plane in the plane direction,
the plurality of capacitor portions include one or more first capacitor portions having largest areas when viewed in the thickness direction and one or more second capacitor portions other than the first capacitor portions, and
when viewed in the thickness direction, a total number of the first through portions and the second through portions inside each of the first capacitor portions is greater than a total number of the first through portions and the second through portions inside each of the second capacitor portions.

4. The capacitor element according to claim 1, wherein at least one of the first through portions or the second through portions is composed of through holes in the form of holes when viewed in the thickness direction.

5. The capacitor element according to claim 4, wherein the through holes extend through the capacitor portions in the thickness direction.

6. The capacitor element according to claim 5, further comprising through conductors on at least inner wall surfaces of the through holes.

7. The capacitor element according to claim 6, wherein a thickness of the through conductors on the inner wall surfaces of the through holes is constant in the thickness direction.

8. The capacitor element according to claim 6, wherein the through conductors are composed of a metal plating material.

9. The capacitor element according to claim 6, wherein
the first through portions and the second through portions are the through holes,
the through conductors in one of the first through portions or the second through portions are electrically connected to the anode layer, and
the through conductors in the other of the first through portions or the second through portions are electrically connected to the cathode layer.

10. The capacitor element according to claim 6, wherein
the first through portions and the second through portions are the through holes, and
the through conductors in the first through portions and the second through portions are electrically connected to the anode layer.

11. The capacitor element according to claim 6, wherein
the first through portions and the second through portions are the through holes, and
the through conductors in the first through portions and the second through portions are electrically connected to the cathode layer.

12. The capacitor element according to claim 1, wherein at least one of the first through portions or the second through portions is composed of through slits in the form of slits when viewed in the thickness direction.

13. The capacitor element according to claim 12, wherein
the capacitor layer includes a plurality of the capacitor portions arranged in a plane in the plane directions, and
the through slits divide the plurality of capacitor portions individually.

14. The capacitor element according to claim 13, further comprising an insulating material filling insides of the through slits.

15. The capacitor element according to claim 12, wherein
the first through portions and the second through portions are the through slits, and
in the plane direction, the first through portions extend in a direction different from a direction in which the second through portions extend.

16. The capacitor element according to claim 1, wherein
the anode layer includes a core portion and a porous portion on at least one main surface of two main surfaces of the core portion opposed to each other in the thickness direction,
the dielectric layer is on a surface of the porous portion, and
the cathode layer is on a surface of the dielectric layer.

17. The capacitor element according to claim 1, wherein the width of the end portion of the first through portion on the first insulation portion side is larger than the width of the end portion of the second through portion on the first insulation portion side.

18. The capacitor element according to claim 1, wherein the width of the end portion of the first through portion on the first insulation portion side is the same as the width of the end portion of the second through portion on the second insulation portion side.

19. The capacitor element according to claim 1, wherein the width of the end portion of the first through portion on the second insulation portion side is smaller than the width of the end portion of the second through portion on the second insulation portion side.

20. The capacitor element according to claim 1, wherein the width of the end portion of the first through portion on the second insulation portion side is the same as the width of the end portion of the second through portion on the first insulation portion side.
